(19) United States
(12) Patent Application Publication
(10) Pub. No.: US 2015/0205316 A1
(43) Pub. Date: Jul. 23, 2015

(54) APPARATUS AND METHOD FOR MANAGING ENERGY INFORMATION PROFILE OF HOME BASED ON SMART PLUG

(71) Applicant: Electronics and Telecommunications Research Institute, Daejeon (KR)

(72) Inventors: Chang Sic CHOI, Daejeon (KR); Jin Soo HAN, Daejeon (KR); Wan Ki PARK, Daejeon (KR); Il Woo LEE, Daejeon (KR)

(21) Appl. No.: 14/302,208

(22) Filed: Jun. 11, 2014

(30) Foreign Application Priority Data
Jan. 23, 2014 (KR) 10-2014-0008252

(51) Int. Cl. G05F 1/66; G05B 15/02

(52) U.S. Cl. CPC G05F 1/66; G05B 15/02

(57) ABSTRACT

The present invention relates to an apparatus and method for managing a home energy information profile based on a smart plug. According to the apparatus for managing a home energy information profile based on a smart plug according to the present invention, it is detected that an energy load device is plugged in or plugged out of the smart plug without adding an additional device such as an RFID tag, and an energy information profile is transmitted to a home energy management server when a corresponding event occurs, so that a user immediately change shape information of the energy load device. According to the present invention, a smart plug manages shape information on a load device plugged in or plugged out of the smart plug on the basis of a plugging in/plugging out event so that information on the load device may constantly match information stored in a home energy management server. Furthermore, energy information on the energy load device may be correctly managed based on the smart plug without adding an additional device such as an RFID.

### CROSS-REFERENCE TO RELATED APPLICATIONS

This application claims priority under 35 U.S.C. §119 to Korean Patent Application No. 10-2014-0008252, filed on Jan. 23, 2014, the disclosure of which is incorporated herein by reference in its entirety.

### TECHNICAL FIELD

The present invention relates to an apparatus and method for managing energy information profile of a home based on a smart plug, and more particularly, to an apparatus and method for managing energy information profiles of a smart plug and an indoor load device in a home energy management system based on a smart plug.

### BACKGROUND

Korean Patent Application No. 10-2011-0113170 relates to a power monitoring system using a smart socket, the system including: a smart plug connected to a plug of a load so that a smart socket installed for each load independently monitors a power state of the load when communication with a home network server fails, and blocks unnecessary standby power, the smart plug including an RFID tag for distinguishing a connected load with a tag value; the smart socket which is provided with an RFID reader to recognize the RFID tag and receive a corresponding tag value while being connected to the smart plug, and supplies power to the load connected to the smart plug to measure power information; the home network server which receives power information including the tag value of the load from the smart socket to calculate power monitoring information, and generates a control command signal for supplying or blocking power of the smart socket to transfer the control command signal to the smart socket; and a user device which receives the power monitoring information from the home network server to display the power monitoring information, and sets a power environment to transfer the power environment to the home network server.

That is, according to the power monitoring system using a smart socket, an RFID tag and an RFID reader are installed between a smart plug and the smart socket so as to distinguish and recognize a load connected to the smart plug with an RFID tag value, and the smart plug equipped with the RFID tag should be constantly attached to a specific load and is registered in advance so as to match shapes when the smart socket recognizes the RFID tag value.

Korean Patent Application No. 10-2011-0141819 relates to a method and system for identifying an electric device, the system including: a smart tag which is installed in a consumer house and measures a power consumption amount for each time slot of an arbitrary electric device connected to a socket; a smart meter which is installed in the consumer house and receives the measured power consumption amount for each time slot of the arbitrary electric device from the smart tag; and an operating center which receives the measured power consumption amount for each time slot of the arbitrary electric device from the smart meter and compares the received power consumption amount for each time slot of the arbitrary electric device with a pre-stored power consumption amount for each time slot of a comparative electric device so as to identify the type of the arbitrary electric device.

That is, the method and system for identifying an electric device are characterized in that the system includes the operating center which receives the measured power consumption amount for each time slot of the arbitrary electric device from the smart meter and compares the received power consumption amount for each time slot of the arbitrary electric device with a pre-stored power consumption amount for each time slot of a comparative electric device so as to identify the type of the arbitrary electric device, and the smart meter includes a second display unit for displaying the types of the smart tag connected to a wired or wireless network and the electric device connected to the smart tag and a second electric device input unit for receiving the type of the electric device connected to the smart tag from a user.

As the cost for producing energy has recently increased, researches for efficient management of energy consumption have been actively conducted. Such researches focused on energy saving methods for consumers of a large amount of energy, such as factories, IDC centers and large buildings. However, such researches have recently focused on home energy management systems for reducing household energy consumption.

A home energy management system, which includes a smart plug and a home energy management server, may measure energy consumption information of each energy load device and may perform a turning on/off operation on each energy load device through a smart plug provided with a wired/wireless communication interface.

For example, the smart plug measures instantaneous power and short-circuit power information of an energy load device connected thereto, and transmits the measured information to the home energy management server through a wired/wireless network such as Ethernet/RS-485/PLC/Zigbee/Wi-Fi.

The energy management server may notify energy usage amount information to a user at intervals of day/month/year so as to induce the user to save energy, and may allow, if a control function is provided, the user to turn on/off an energy load device connected to the smart plug through the control function.

Such a home energy management system based on a smart plug manages shape information on a connected energy load device. However, when a shape change of an energy load device occurs, e.g., when the energy load device is moved to and connected to another smart plug or is added/deleted, the home energy management system is unable to appropriately handle the shape change.

That is, according to the related art, in the case where an energy load device is connected to a smart plug installed in a home, shape management for the energy load device is performed in such a manner that a user arbitrarily and manually sets information on the energy load device in a home energy management server, and thus, the user may mistakenly omit information.

Therefore, recently, researches have been actively conducted to develop technologies for automatically associating information on an energy load device with a new smart plug when the energy load device is moved and connected to the new smart plug by adding a recognition device such as an RFID tag, so as to improve convenience of users.

However, such technologies may provide improved convenience to users, but cause additional cost for adding additional devices.

### SUMMARY

Accordingly, the present invention provides an apparatus and method for managing a home energy information profile based on a smart plug, according to which it is detected that an energy load device is plugged in or plugged out of the smart plug without adding an additional device such as an RFID tag, and an energy information profile is transmitted to a home energy management server when a corresponding event occurs, so that a user immediately change shape information of the energy load device.

The present invention enables a smart plug to manage shape information of an energy load device plugged in the smart plug and match the shape information of the energy load device to that of a home energy management server by allowing a user to change the shape information via the home energy management server on the basis of an event of plugging in/plugging out of the load device.

In one general aspect, an apparatus for managing a home energy information profile based on a smart plug installed in a home where an energy load device is positioned includes: a plug in/out state detection unit configured to detect whether the energy load device is plugged in or plugged out; and a home energy information profile transmitting unit configured to transmit a home energy information profile of the energy load device to a home energy management server when detection information according to whether the energy load device is plugged in or plugged out is received.

In another general aspect, an apparatus for managing a home energy information profile based on a smart plug includes: a smart plug configured to transmit a home energy information profile of an energy load device when the energy load device located in a home is plugged in or plugged out of the smart plug; and a home energy management server configured to request a user to set shape information of the energy load device via a user interface, and apply the shape information of the energy load device set by the user to the home energy information profile, upon receiving the home energy information profile from the smart plug.

In another general aspect, a method for managing a home energy information profile based on a smart plug includes: transferring a home energy information profile of an energy load device to a home energy management server, when it is detected that the energy load device located in a home is plugged in or plugged out; and updating, when a home energy information profile to which user setting information of the energy load device is applied is received from the home energy management server, the home energy information profile of the energy load device on the basis of the received home energy information profile.

Other features and aspects will be apparent from the following detailed description, the drawings, and the claims.

### BRIEF DESCRIPTION OF THE DRAWINGS

FIG. 1 is a diagram for describing the concept of an apparatus for managing a home energy information profile based on a smart plug according to an embodiment of the present invention.

FIG. 2 is a diagram illustrating a home energy management server and a smart plug of the present invention.

FIG. 3 is a diagram for describing a method for managing shape information on a smart plug according to an embodiment of the present invention.

FIG. 4 is a diagram for describing a method for processing a home energy information profile when an energy load device is plugged in a smart plug installed in a home.

FIG. 5 is a diagram for describing a method for processing a home energy information profile when an energy load device is plugged out of a smart plug and is plugged in another smart plug.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

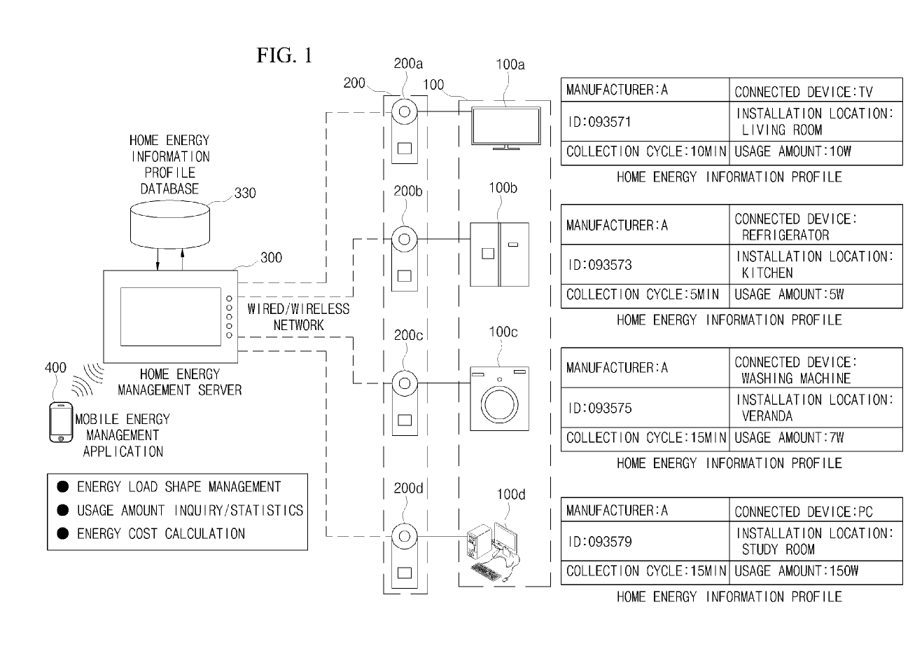

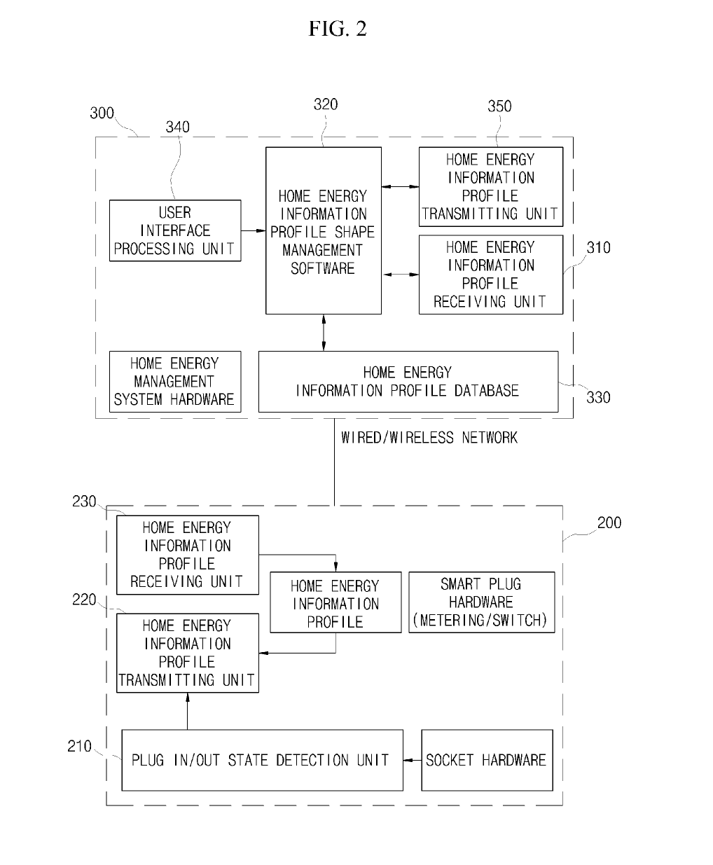

Hereinafter, an apparatus for managing a home energy information profile based on a smart plug according to an embodiment of the present invention will be described with reference to FIGS. 1 and 2. FIG. 1 is a diagram for describing the concept of the apparatus for managing a home energy information profile based on a smart plug according to an embodiment of the present invention, and FIG. 2 is a diagram illustrating a home energy management server and a smart plug of the present invention.

As illustrated in FIG. 1, the apparatus for managing a home energy information profile based on a smart plug of the present invention includes at least one energy load device 100 and at least one smart plug 200.

Each energy load device 100 may be a TV, a refrigerator, a washing machine, or a computer installed or mounted in a home.

Before providing detailed descriptions of the present invention, the home energy information profile is described. The home energy information profile may be classified into a home energy information profile managed by each smart plug 200 and a home energy information profile managed by a home energy management server 300.

The home energy information profile managed by each smart plug 200 may include shape information of each smart plug 200 and shape information of each load device 100 plugged in each smart plug 200. Here, the shape information of each energy load device 100 may include location information and information on a connection to each smart plug 200, and the shape information of each smart plug 200 may include location information, information on a connection to each energy load device 100, a cycle of collecting an energy usage amount of each connected energy load device 100 and an energy usage amount of each connected energy load device 100.

The home energy information profile managed by the home energy management server 300 may be classified into a home energy information profile that is stored and managed in a home energy information profile database 330 in association with each smart plug 200 and a home energy information profile that is stored and managed in the home energy information profile database 330 in association with each energy load device 100. The home energy information profile stored and managed in the home energy information profile database 330 in association with each smart plug 200 may include shape information of each smart plug 200, and the home energy information profile stored and managed in the home energy information profile database 330 in association with each energy load device 100 may include shape information of each energy load device 100.

When each smart plug 200 detects that one of the energy load devices 100 is plugged therein or plugged out thereof according to installation, movement or removal of each energy load device 100 by a user, each smart plug 200 transmits the home energy information profile thereof to the home energy management server 300.

When the home energy management server 300 receives the home energy information profile from each smart plug 200, e.g., when an energy load device 100a is plugged in a smart plug 200a and the home energy management server 300 receives the home energy information profile from the smart plug 200a, the home energy management server 300 requests the user to set shape information on the energy load device 100a, and applies the shape information of the energy load device 100a set by the user to the home energy information profile received from the smart plug 200a.

The home energy management server 300 checks whether the home energy information profile corresponding to the energy load device 100a exists in the home energy information profile database 330. If the home energy information profile corresponding to the energy load device 100a does not exist, the home energy management server 300 forms a home energy information profile of the energy load device 100a on the basis of the home energy information profile to which the shape information set by the user is applied, and stores and manages the formed home energy information profile of the energy load device 100a in the home energy information profile database 330.

If the home energy information profile corresponding to the energy load device 100a exists, the home energy management server 300 changes and manages the home energy information profile stored in the home energy information profile database 330 in association with energy load device 100a, on the basis of the home energy information profile to which the shape information set by the user is applied.

When the specific energy load device 100a is plugged out of the specific smart plug 200a, the home energy management server 300 does not delete the shape information of the specific energy load device 100a from the home energy information profile stored in the home energy profile database 300 in association with the specific energy load device 100a, and merely changes connection information of the specific energy load device 100a from connection establishment to connection release with respect to the specific smart plug 200a, so as to manage a history of each energy load device 100.

For example, in the case where the specific energy load device 100a is plugged out of the specific smart plug 200a and is moved to and plugged in another smart plug 200b, if the home energy management server 300 receives the home energy information profile from the other smart plug 200b, the home energy management server 300 checks whether the home energy information profile corresponding to the specific energy load device 100a exists in the home energy information profile database 330 on the basis of the home energy information profile of the received home energy information profile of the other smart plug 200b.

If the home energy information profile corresponding to the specific energy load device 100a exists in the home energy information profile database 330, the home energy management server 300 merely changes connection information of the specific energy load device 100a in the home energy information profile corresponding to the specific energy load device 100a so that the connection information is changed from release of connection to the specific smart plug 200a to establishment of connection to the other smart plug 200b, thereby managing a history of the home energy information profile corresponding to the specific energy load device 100a.

Hereinafter, each smart plug 200 and the home energy management server 300 will be described in more detail with respect to FIG. 2.

As illustrated in FIG. 2, each smart plug 200 includes a plug in/out state detection unit 210, a home energy information profile transmitting unit 220, and a home energy information profile receiving unit 230.

Hereinafter, the specific smart plug 200a and the specific energy load device 100a will be exemplarily described.

The plug in/out state detection unit 210 detects whether the specific energy load device 100a is plugged in or plugged out of the smart plug 200a, and transfers detected information to the home energy information profile transmitting unit 220.

When the detected information is transferred from the plug in/out state detection unit 210 to the home energy information profile transmitting unit 220, the home energy information profile transmitting unit 220 transmits a home energy information profile to the home energy management server 300 through a wired/wireless network.

The home energy management server 300 includes a home energy information profile receiving unit 310, home energy information profile shape management software 320, the home energy information profile database 330, a user interface processing unit 340, and a home energy information profile transmitting unit 350.

Upon receiving the home energy information profile from the smart plug 200a, the home energy information profile receiving unit 310 transfers the home energy information profile to the home energy information profile shape management software 320.

Upon receiving the home energy information profile from the home energy information profile receiving unit 310, the home energy information profile shape management software 320 requests a user to set the shape information on the energy load device 100a via the user interface processing unit 340, and applies the shape information on the energy load device 100a set by the user to the home energy information profile.

The home energy information profile shape management software 320 checks whether the home energy information profile corresponding to the energy load device 100a exists in the home energy information profile database 330. If the home energy information profile corresponding to the energy load device 100a does not exist, the home energy information profile shape management software 320 forms a home energy information profile corresponding to the energy load device 100a on the basis of the home energy information profile to which the shape information set by the user is applied, and stores and manages the formed home energy information profile in the home energy information profile database 330.

On the contrary, if the home energy information profile corresponding to the energy load device 100a exists, the home energy information profile shape management software 320 changes and manages the home energy information profile corresponding to the energy load device 100a on the basis of the shape information set by the user.

The home energy information profile shape management software 320 transfers the home energy information profile to which the shape information set by the user is applied to the home energy information profile transmitting unit 350.

The home energy information profile transmitting unit 350 transmits the home energy information profile received from the home energy information profile shape management software 320 to the smart plug 200a.

The home energy information profile receiving unit 230 receives the home energy information profile transmitted by the home energy information profile transmitting unit 350.

The user interface processing unit 340 sends a request message to a user interface 400 such as a mobile energy management application so that the user checks the message, and receives information set by the user according to the request so as to transfer the received information to the home energy information profile shape management software 320.

As described above, according to the present invention, the home energy information profile of each smart plug 200 and the home energy information profiles managed by the home energy management server 300 in association with each smart plug 200 and each energy load device 100 may match each other. Accordingly, consistency between actual shape information on each energy load device 100 and each smart plug 200 and the shape information managed by the home energy management server 300 may be guaranteed, and convenience in managing each energy load device 100 may be improved without causing a cost increase due to addition of a device.

It has been described that the home energy information profile stored and managed by the home energy management server is classified into a home energy information profile corresponding to a smart plug and a home energy information profile corresponding to an energy load device. However, the present invention is not limited thereto, and thus, the home energy information profile may be stored as a single home energy information profile without the classification by the smart plug and energy load device.

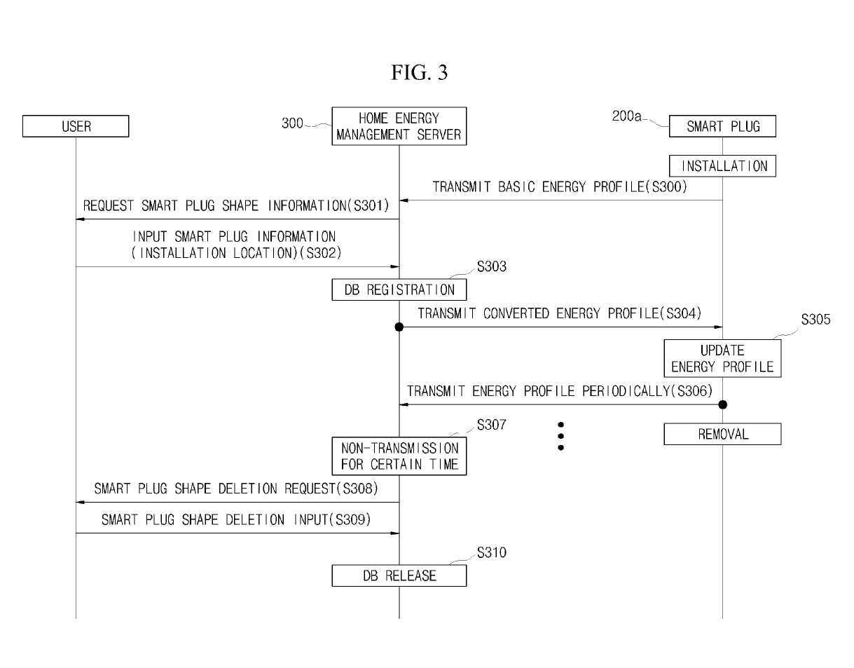

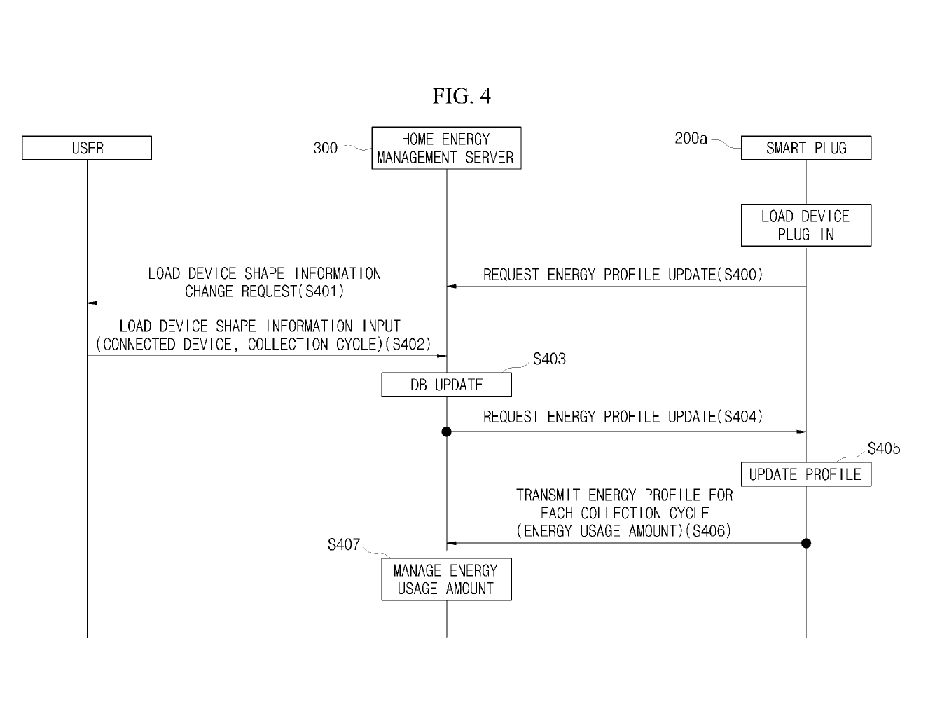

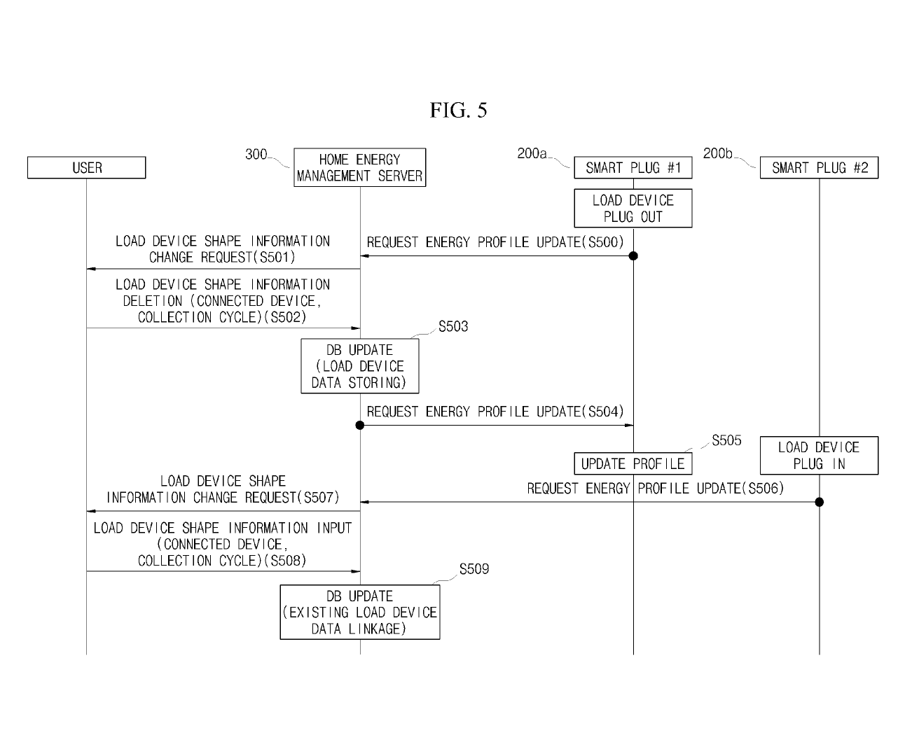

The apparatus for managing a home energy information profile based on a smart plug according to an embodiment of the present invention has been described with reference to FIGS. 1 and 2. Hereinafter, a method for managing a home energy information profile based on a smart plug according to an embodiment of the present invention will be described with reference to FIGS. 3 to 5. FIG. 3 is a diagram for describing a method for managing shape information on a smart plug according to an embodiment of the present invention, FIG. 4 is a diagram for describing a method for processing a home energy information profile when an energy load device is plugged in a smart plug installed in a home, and FIG. 5 is a diagram for describing a method for processing the home energy information profile when the energy load device is plugged out of the smart plug and is plugged in another smart plug.

The method for managing shape information on a smart plug may be divided into: registering the shape information on the smart plug 200a in the home energy information profile database 330, when the smart plug 200a is initially installed in a home by a user; and deleting the shape information on the smart plug 200a from the home energy information profile database 330, when the smart plug 200a is broken or is not used any more in the home.

In detail, as illustrated in FIG. 3, when the smart plug 200 is installed in the home, the smart plug 200a transmits the home energy information profile thereof to the home energy management server 300 (step S300).

Upon receiving the home energy information profile from the smart plug 200a, the home energy management server 300 requests a user to set the shape information on the smart plug 200a via the user interface processing unit 340 on the basis of the received home energy information profile (step S301), and receives the shape information including location information of the smart plug 200a set by the user (step S302).

The home energy management server 300 applies the shape information on the smart plug 200a set by the user to the home energy information profile received from the smart plug 200a, registers (stores) the home energy information profile to which the shape information set by the user is applied in the home energy information profile database 330 in association with the smart plug 200a (step S303), and transmits the home energy information profile to the smart plug 200a (step S304).

The smart plug 200a updates the home energy information profile thereof on the basis of the home energy information profile received from the home energy management server 300 (step S305).

Thereafter, the smart plug 200a collects energy information of the energy load device 100a plugged therein at preset intervals, and applies the collected energy information to the home energy information profile of the smart plug 200a to transmit the home energy information profile to the home energy management server 300 (step S306).

When the smart plug 200a is broken or is not used in the home any more, the smart plug 200a is unable to transmit the home energy information profile thereof to the home energy management server 300 at preset intervals.

Therefore, if the home energy information profile is not received from the smart plug 200a for a preset time (step S307), the home energy management server 300 requests the user to delete the shape information on the smart plug 200a via the user interface processing unit 340 (step S308).

When the home energy management server 300 receives a request for deleting the shape information on the smart plug 200a set by the user via the user interface processing unit 340 (step S309), the home energy management server 300 deletes the home energy information profile corresponding to the smart plug 200a from the home energy information profile database 330 (step S310).

Hereinafter, the method for processing a home energy information profile when an energy load device is plugged in a smart plug installed in a home will be described with reference to FIG. 4.

As illustrated in FIG. 4, when the smart plug 200a detects that the energy load device 100a is plugged therein, the smart plug 200a transmits the home energy information profile thereof to the home energy management server 300 and requests update of the home energy information profile (step S400).

Upon receiving the home energy information profile and the request for updating the home energy information profile from the smart plug 200a, the home energy management server 300 requests the user to change a setting of the shape information on the energy load device 100a via the user interface processing unit 340 (step S401), and receives the shape information including a name and collection cycle of the energy load device 100a, of which the setting has been changed by the user (step S402).

The home energy management server 300 applies the setting-changed shape information to the home energy information profile received from the smart plug 200a, and updates the home energy information profile stored in the file database 330a in association with the energy load device 100a on the basis of the setting-changed shape information (step S403).

For example, the home energy management server 300 checks whether the home energy information profile corresponding to the energy load device 100a exists in the home energy information profile database 330. If the home energy information profile corresponding to the energy load device 100a does not exist, the home energy management server 300 forms a home energy information profile of the energy load device 100a on the basis of the home energy information profile to which the setting-changed shape information is applied, and stores (registers) the formed home energy information profile of the energy load device 100a in the home energy information profile database 330. On the contrary, if the home energy information profile corresponding to the energy load device 100a exists, the home energy management server 300 updates the home energy information profile corresponding to the energy load device 100a on the basis of the setting-changed shape information.

The home energy information profile to which the setting-changed shape information is applied is transmitted to the smart plug 200a in order to request update (step S404).

Upon receiving the home energy information profile to which the setting-changed shape information is applied and the request for updating the same from the home energy management server 300, the smart plug 200a updates the home energy information profile thereof on the basis of the received home energy information profile (step S405).

The smart plug 200a collects information such as an energy usage amount of the energy load device 100a according to a collection cycle preset by the user, and applies the collected information to the home energy information profile of the smart plug 200a to transmit the home energy information profile to the home energy management server 300 (step S406).

The home energy management server 300 applies the collected energy usage information of the energy load device 100a to the home energy information profile stored in the home energy information profile database 330 in association with the energy load device 100a, on the basis of the home energy information profile received from the smart plug 200a (step S407).

The home energy management server 300 may provide various monitoring/statistics/analysis services through a user application service on the basis of the home energy information profiled stored in the home energy information profile database 300 in association with each energy load device 100.

Hereinafter, the method for processing a home energy information profile when an energy load device is plugged out of a smart plug and is plugged in another smart plug will be described with reference to FIG. 5.

As illustrated in FIG. 5, when the smart plug #1 200a detects that the energy load device 100a is plugged therein, the smart plug #1 200a transmits the home energy information profile thereof to the home energy management server 300 and requests update of the home energy information profile (step S500).

Upon receiving the home energy information profile and the request for updating the home energy information profile from the smart plug #1 200a, the home energy management server 300 requests the user to change a setting of the shape information on the energy load device 100a via the user interface processing unit 340 (step S501), and receives a request for deleting the setting-changed shape information on the energy load device 100a plugged out of the smart plug #1 200a (step S502).

When the request for deleting the shape information on the energy load device 100a is input, the home energy management server 300 reflects the deletion of the shape information on the energy load device 100a in order to update the home energy information profile stored in the home energy information profile database 330 in association with the energy load device 100a (step S503).

For example, the home energy management server 300 merely changes linkage information from connection establishment to connection release with respect to the smart plug #1 200a, without deleting the shape information from the home energy information profile corresponding to the energy load device 100a.

That is, since the energy load device 100a may be plugged out of the smart plug #1 200a and may be moved to and plugged in another smart plug, e.g., a smart plug #2 200b, the home energy management server 300 merely changes the linkage information from connection establishment to connection release, without deleting the shape information from the home energy information profile stored in the home energy information profile database 330 in association with the energy load device 100a, even though a deletion setting of the shape information of the energy load device 100a is input according to the plugging out the energy load device 100a, in order to manage the shape information of the energy load device 100a plugged in the smart plug #2 200a in association with the shape information obtained when the energy load device is plugged in the smart plug #1 200a.

The home energy management server 300 transmits the home energy information profile to which the deletion setting of the shape information on the energy load device 100a is applied to the smart plug #1 200a, and requests update (step S504).

Upon receiving the home energy information profile to which the deletion setting of the shape information on the energy load device 100a is applied and the request for updating the same from the home energy management server 300, the smart plug #1 200a updates the home energy information profile thereof on the basis of the received home energy information profile (step S505).

In the case where the energy load device 100a is moved to and plugged in the smart plug #2 200b, when the smart plug #2 200b detects that the energy load device 100a is plugged therein, the smart plug #2 200b transmits the home energy information profile thereof to the home energy management server 300 and requests update of the home energy information profile (step S506).

Upon receiving the home energy information profile and the request for updating the home energy information profile from the smart plug #2 200b, the home energy management server 300 requests the user to change a setting of the shape information on the energy load device 100a via the user interface processing unit 340 (step S507), and receives the shape information including a name and collection cycle of the energy load device 100a, of which the setting has been changed by the user (step S508).

The home energy management server 300 reflects the setting-changed shape information in order to update the home energy information profile stored in the home energy information profile database 330 in association with the energy load device 100a (step S509).

For example, the home energy management server 300 checks whether the home energy information profile corresponding to the energy load device 100a exists in the home energy information profile database 330. If the home energy information profile corresponding to the energy load device 100a exists, the home energy management server 300 changes linkage information of the home energy profile corresponding to the energy load device 100a from release of linkage to the smart plug #1 200a to establishment of linkage to the smart plug #2 200b, in order to manage current shape information on the energy load device 100a plugged in the smart plug #2 200b in association with the shape information obtained when the energy load device 100a is plugged in the smart plug #1 200a.

As described above, according to the present invention, a smart plug manages shape information on a load device plugged in or plugged out of the smart plug on the basis of a plugging in/plugging out event so that information on the load device may constantly match information stored in a home energy management server. Furthermore, energy information on the energy load device may be correctly managed based on the smart plug without adding an additional device such as an RFID.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for managing a home energy information profile based on a smart plug installed in a home where an energy load device is positioned, the smart plug comprising:
a plug in/out state detection unit configured to detect whether the energy load device is plugged in or plugged out; and
a home energy information profile transmitting unit configured to transmit a home energy information profile of the energy load device to a home energy management server when detection information according to whether the energy load device is plugged in or plugged out is received.

2. The apparatus of claim 1, wherein the smart plug further comprises:
a home energy information profile receiving unit configured to receive a home energy information profile to which user setting information of the energy load device is applied from the home energy management server,
wherein the home energy information profile of the energy load device is updated on the basis of the home energy information profile received by the home energy information profile receiving unit.

3. The apparatus of claim 1, wherein
the home energy information profile comprises shape information of the smart plug and shape information of the energy load device plugged in the smart plug,
the shape information of the energy load device comprises location information and information on connection to the smart plug, and
the shape information of the smart plug comprises location information, information on connection to the energy load device, a collection cycle of an energy usage amount of a connected energy load device, and the energy usage amount of the connected energy load device.

4. The apparatus of claim 3, wherein
the home energy information profile is classified into a home energy information profile stored and managed in a home energy information profile database in association with the smart plug and a home energy information profile stored and managed in the home energy information profile data base in association with the energy load device,
the home energy information profile stored and managed in association with the smart plug comprises the shape information of the smart plug, and
the home energy information profile stored and managed in association with the energy load device comprises the shape information of the energy load device.

5. An apparatus for managing a home energy information profile based on a smart plug, the apparatus comprising:
a smart plug configured to transmit a home energy information profile of an energy load device when the energy load device located in a home is plugged in or plugged out of the smart plug; and
a home energy management server configured to request a user to set shape information of the energy load device via a user interface, and apply the shape information of the energy load device set by the user to the home energy information profile, upon receiving the home energy information profile from the smart plug.

6. The apparatus of claim 5, wherein the home energy management server stores and manages the home energy information profile to which the shape information is applied in a home energy information profile database, and transmits the home energy information profile to which the shape information is applied so that the smart plug updates the home energy information profile of the energy load device.

7. The apparatus of claim 5, wherein the home energy management server forms the home energy information profile of the energy load device on the basis of the home energy information profile to which the set shape information is applied, and stores and manages the formed home energy information profile of the energy load device in the home energy information profile database, when the home energy information profile of the energy load device does not exist in the home energy information profile database.

8. The apparatus of claim 5, wherein the home energy management server changes and manages the home energy information profile of the energy load device on the basis of the home energy information profile to which the set shape information is applied, when the home energy information profile of the energy load device exists in the home energy information profile database.

9. The apparatus of claim 8, wherein the home energy management server changes connection information of the home energy information profile of the energy load device from establishment of connection to the smart plug to release of connection to the smart plug in order to manage a history of the energy load device, when the energy load device is plugged out of the smart plug.

10. The apparatus of claim 5, wherein the home energy management server comprises:
home energy information profile shape management software configured to transfer a shape information setting message for the energy load device to a user, apply the shape information of the energy load device set by the user to the home energy information profile, and transfer the home energy information profile to which the set shape information is applied to the smart plug, upon receiving the home energy information profile from the smart plug; and
a user interface processing unit configured to request the user to set the shape information on the energy load device when the shape information setting message is transferred, and, when the shape information on the energy load device set by the user is input, transfer the input shape information on the energy load device to the home energy information profile shape management software.

11. A method for managing a home energy information profile based on a smart plug, the method comprising:
transferring a home energy information profile of an energy load device to a home energy management server, when it is detected that the energy load device located in a home is plugged in or plugged out; and
updating, when a home energy information profile to which user setting information of the energy load device is applied is received from the home energy management server, the home energy information profile of the energy load device on the basis of the received home energy information profile.

12. The method of claim 11, further comprising:
requesting, by the home energy management server, a user to set shape information of the energy load device via a user interface, when the home energy information profile is received from the smart plug;
applying the shape information set by the user to the received home energy information profile; and
storing and managing the home energy information profile to which the set shape information is applied in a home energy information profile database.

13. The method of claim 12, wherein the storing and managing comprises:
forming, by the home energy management server, the home energy information profile of the energy load device on the basis of the home energy information profile to which the set shape information of the energy load device is applied, when the home energy information profile of the energy load device does not exist in the home energy information profile database; and
storing and managing the formed home energy information profile of the energy load device in the home energy information profile database.

14. The method of claim 12, wherein the storing and managing comprises:
changing and managing, by the home energy management server, the home energy information profile of the energy load device on the basis of the home energy information profile to which the set shape information is applied, when the home energy information profile of the energy load device exists in the home energy information profile database.

15. The method of claim 14, wherein the storing and managing comprises:
changing connection information of the home energy information profile of the energy load device from establishment of connection to the smart plug to release of connection to the smart plug in order to manage a history of the energy load device, when it is detected that the energy load device is plugged out.

16. The method of claim 11, further comprising:
providing, by the home energy management server, monitoring/statistics/analysis services to a user via a user application service on the basis of the home energy information profile stored in the home energy information profile database.

17. The method of claim 11, wherein
the home energy information profile of the smart plug comprises shape information of the smart plug and shape information of the energy load device plugged in the smart plug,
the shape information of the energy load device comprises location information and information on connection to the smart plug, and
the shape information of the smart plug comprises location information, information on connection to the energy load device, a collection cycle of an energy usage amount of a connected energy load device, and the energy usage amount of the connected energy load device.

18. The method of claim 12, wherein
the home energy information profile stored and managed in the home energy information profile database is classified into a home energy information profile stored and managed in a home energy information profile database in association with the smart plug and a home energy information profile stored and managed in the home energy information profile data base in association with the energy load device,
the home energy information profile stored and managed in association with the smart plug comprises the shape information of the smart plug, and
the home energy information profile stored and managed in association with the energy load device comprises the shape information of the energy load device.
